(19) United States
(12) Patent Application Publication
(10) Pub. No.: US 2025/0118754 A1
(43) Pub. Date: Apr. 10, 2025

(54) NEGATIVE ELECTRODE FOR SECONDARY BATTERY, AND SECONDARY BATTERY

(71) Applicant: MURATA MANUFACTURING CO., LTD., Kyoto (JP)

(72) Inventor: Nobuhiro INOUE, Kyoto (JP)

(21) Appl. No.: 18/984,586

(22) Filed: Dec. 17, 2024

Related U.S. Application Data
(63) Continuation of application No. PCT/JP2023/021492, filed on Jun. 9, 2023.

(30) Foreign Application Priority Data
Sep. 12, 2022 (JP) 2022-144501

(51) Int. Cl. H01M 4/62; H01M 4/02; H01M 4/133; H01M 10/0525; H01M 10/42

(52) U.S. Cl. CPC H01M 4/62; H01M 4/133; H01M 10/0525; H01M 10/4235; H01M 2004/027

(57) ABSTRACT

The secondary battery includes a positive electrode, a negative electrode, and an electrolytic solution. The negative electrode includes a negative electrode active material layer. The negative electrode active material layer includes an alkali metal carbonic acid compound and a magnesium compound. The alkali metal carbonic acid compound has a carbonate bond (—OC(═O)O—), and includes an alkali metal element as a constituent element. The magnesium compound includes magnesium as a constituent element.

### CROSS REFERENCE TO RELATED APPLICATIONS

The present application is a continuation of PCT patent application no. PCT/JP2023/021492, filed on Jun. 9, 2023, which claims priority to Japanese patent application no. 2022-144501, filed on Sep. 12, 2022, the entire contents of which are incorporated herein by reference.

### BACKGROUND

The present technology relates to a negative electrode for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode (a negative electrode for a secondary battery), and an electrolytic solution. A configuration of the secondary battery has been considered in various ways.

Specifically, a negative electrode active material layer includes ceramic nano-particles (MgO) together with a negative electrode active material (a carbon material). An anode active material includes (CH₂OCO₂Li)₂ as a lithium-ion electrically conductive additive. At least one of a positive electrode, a negative electrode, or a non-aqueous electrolyte includes a basic compound, and the basic compound includes an anion (NO₂⁻) and a cation (Mg²⁺). A binder of an electrode includes a polymer compound, and the polymer compound includes an anion (NO₃⁻ or NO₂⁻) and a cation (Mg²⁺).

### SUMMARY

The present technology relates to a negative electrode for a secondary battery, and to a secondary battery.

Although consideration has been given in various ways regarding a configuration of a secondary battery, a battery characteristic of the secondary battery is not sufficient yet. Accordingly, there is room for improvement in terms of the battery characteristic.

It is desirable to provide a negative electrode for a secondary battery and a secondary battery each of which makes it possible to achieve a superior battery characteristic.

A negative electrode for a secondary battery according to an embodiment of the present technology includes a negative electrode active material layer. The negative electrode active material layer includes an alkali metal carbonic acid compound and a magnesium compound. The alkali metal carbonic acid compound has a carbonate bond (—OC(═O)O—), and includes an alkali metal element as a constituent element. The magnesium compound includes magnesium as a constituent element.

A secondary battery according to an embodiment of the present technology includes a positive electrode, a negative electrode, and an electrolytic solution. The negative electrode has a configuration similar to the configuration of the negative electrode for the secondary battery according to an embodiment of the present technology described above.

According to the negative electrode for the secondary battery of an embodiment of the present technology or the secondary battery of an embodiment of the present technology, the negative electrode for the secondary battery includes the negative electrode active material layer, and the negative electrode active material layer includes the alkali metal carbonic acid compound and the magnesium compound. Accordingly, it is possible to achieve a superior battery characteristic.

Note that effects of the present technology are not necessarily limited to those described above and may include any of a series of effects described below in relation to the present technology.

### BRIEF DESCRIPTION OF THE FIGURES

FIG. 1 is a sectional diagram illustrating a configuration of a negative electrode for a secondary battery according to an embodiment of the present technology.

FIG. 2 is a perspective diagram illustrating a configuration of a secondary battery according to an embodiment of the present technology.

FIG. 3 is a sectional diagram illustrating a configuration of a battery device illustrated in FIG. 2.

FIG. 4 is a plan diagram illustrating a configuration of a positive electrode illustrated in FIG. 3.

FIG. 5 is a plan diagram illustrating a configuration of a negative electrode illustrated in FIG. 3.

FIG. 6 is a perspective diagram for describing a method of manufacturing the secondary battery.

FIG. 7 is a block diagram illustrating a configuration of an application example of the secondary battery.

### DETAILED DESCRIPTION

The present technology will be described below in further detail including with reference to the drawings.

A description is given first of a negative electrode for a secondary battery (hereinafter, simply referred to as a “negative electrode”) according to an embodiment of the present technology.

The negative electrode to be described here is to be used in a secondary battery, which is an electrochemical device. However, the negative electrode may be used in electrochemical devices other than a secondary battery. Specific examples of the other electrochemical devices include a primary battery and a capacitor.

An electrode reactant is to be inserted into and extracted from the negative electrode upon an electrode reaction of the electrochemical device. The electrode reactant is not particularly limited in kind, and is specifically a light metal such as an alkali metal or an alkaline earth metal. Specific examples of the alkali metal include lithium, sodium, and potassium. Specific examples of the alkaline earth metal include beryllium, magnesium, and calcium.

Examples are given below of a case where the electrode reactant is lithium. Lithium is inserted into and extracted from the negative electrode in an ionic state upon the electrode reaction.

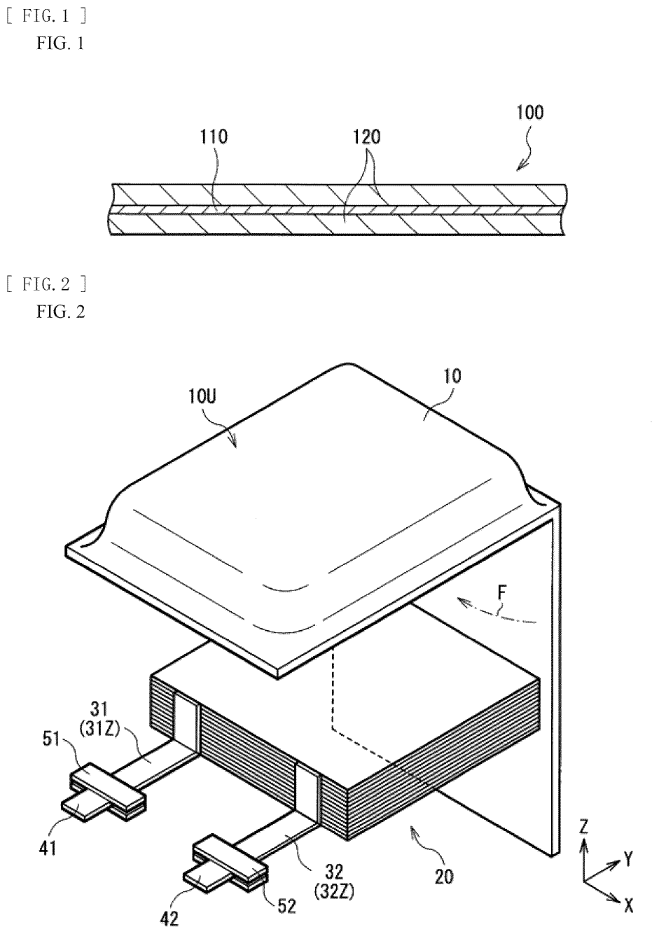

FIG. 1 illustrates a sectional configuration of a negative electrode 100 that is an example of the negative electrode. The negative electrode 100 includes a negative electrode active material layer 120, as illustrated in FIG. 1. Here, the negative electrode 100 further includes a negative electrode current collector 110 that supports the negative electrode active material layer 120.

The negative electrode current collector 110 is an electrically conductive support that supports the negative electrode active material layer 120, and has two opposed surfaces on each of which the negative electrode active material layer 120 is to be provided. The negative electrode current collector 110 includes any one or more of electrically conductive materials including, without limitation, a metal material. Specific examples of the electrically conductive material include copper.

A surface of the negative electrode current collector 110 is preferably roughened by a method such as an electrolytic method. One reason for this is that adherence of the negative electrode active material layer 120 to the negative electrode current collector 110 is improved using what is called an anchor effect.

Note, however, that the negative electrode current collector 110 may be omitted. In other words, the negative electrode 100 may include no negative electrode current collector 110, and include only the negative electrode active material layer 120.

The negative electrode active material layer 120 includes an alkali metal carbonic acid compound and a magnesium compound. Here, the negative electrode active material layer 120 further includes a negative electrode active material into which lithium is to be inserted and from which lithium is to be extracted. Note that the negative electrode active material layer 120 may further include any one or more of other materials including, without limitation, a negative electrode binder and a negative electrode conductor.

Here, the negative electrode active material layer 120 is provided on each of the two opposed surfaces of the negative electrode current collector 110. Note, however, that the negative electrode active material layer 120 may be provided only on one of the two opposed surfaces of the negative electrode current collector 110. A method of forming the negative electrode active material layer 120 is not particularly limited, and specifically includes a method such as a coating method.

The negative electrode active material is not particularly limited in kind and specifically includes any one or more of materials including, without limitation, a carbon material and a metal-based material. That is, the negative electrode active material may include only the carbon material, only the metal-based material, or both of the carbon material and the metal-based material. One reason for this is that a high energy density is obtainable. However, the kind of the negative electrode active material may be any material other than the carbon material and the metal-based material.

The term “carbon material” is a generic term for a material including carbon as a constituent element. A crystal structure of the carbon material hardly varies upon insertion and extraction of lithium. Thus, a high energy density is stably obtainable in the negative electrode active material layer 120. Further, the carbon material also serves as the negative electrode conductor. Thus, improved electrical conductivity is obtained in the negative electrode active material layer 120.

Specific examples of the carbon material include graphitizable carbon, non-graphitizable carbon, and graphite. The graphite may be natural graphite, artificial graphite, or both. Spacing of a (002) plane of the non-graphitizable carbon is not particularly limited and is specifically greater than or equal to 0.37 nm. Spacing of a (002) plane of the graphite is not particularly limited and is specifically less than or equal to 0.34 nm.

Specific examples of the carbon material also include pyrolytic carbons, cokes, glassy carbon fibers, an organic polymer compound fired body, activated carbon, and carbon blacks. Examples of the cokes include pitch coke, needle coke, and petroleum coke. The organic polymer compound fired body is a resultant of firing or carbonizing a polymer compound such as a phenol resin or a furan resin at an appropriate temperature. Other than the above, the carbon material may be low-crystalline carbon subjected to heat treatment at a temperature of about 1000° C. or lower, or may be amorphous carbon. The carbon material is not particularly limited in shape, and specific examples thereof include any one or more shapes including, without limitation, a fibrous shape, a spherical shape, a granular shape, and a flaky shape.

The term “metal-based material” is a generic term for a material that includes, as one or more constituent elements, any one or more elements among metal elements and metalloid elements that are each able to form an alloy with lithium. The metal-based material has a higher energy density. Thus, a higher energy density is obtainable in the negative electrode active material layer 120.

The metal-based material may be a simple substance, an alloy, a compound, a mixture of two or more thereof, or a material including one or more phases thereof. The “simple substance” described here merely refers to a simple substance in a general sense. The simple substance may therefore include a small amount of impurity. That is, purity of the simple substance does not necessarily have to be 100%.

Note, however, that the “alloy” described here includes not only a material including two or more metal elements as constituent elements, but also a material including one or more metal elements and one or more metalloid elements as constituent elements. Additionally, the “alloy” may further include one or more non-metallic elements as one or more constituent elements. The metal-based material is not particularly limited in state, but specifically includes any one or more states including, without limitation, a solid solution, a eutectic (a eutectic mixture), an intermetallic compound, and a state including two or more thereof that coexist.

Specific examples of the metal element and the metalloid element include magnesium, boron, aluminum, gallium, indium, silicon, germanium, tin, lead, bismuth, cadmium, silver, zinc, hafnium, zirconium, yttrium, palladium, and platinum.

In particular, the metal-based material is preferably a silicon-containing material. The silicon-containing material has an excellent lithium insertion capacity and an excellent lithium extraction capacity. Thus, a markedly high energy density is obtainable in the negative electrode active material layer 120. The term “silicon-containing material” is a generic term for a material including silicon as a constituent element. That is, the silicon-containing material may be a simple substance of silicon, a silicon alloy, a silicon compound, a mixture of two or more thereof, or a material including one or more phases thereof.

The silicon alloy includes any one or more of metal elements including, without limitation, tin, nickel, copper, iron, cobalt, manganese, zinc, indium, silver, titanium, germanium, bismuth, antimony, and chromium as one or more constituent elements other than silicon. The silicon compound includes any one or more of non-metallic elements including, without limitation, carbon and oxygen as one or more constituent elements other than silicon. Note, however, that the silicon compound may include, as one or more constituent elements other than silicon, any one or more of the series of metal elements described in relation to the silicon alloy.

Specific examples of the silicon alloy include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, and SiC. Note, however, that a composition of the silicon alloy (a mixture ratio between silicon and the metal element) may be changed as desired.

Specific examples of the silicon compound include Si₃N₄, Si₂N₂O, SiOₓ (where 0<x≤2), and LiSiO. Note, however, that a range of “x” may be 0.2<x<1.4.

In particular, the negative electrode active material preferably includes both the carbon material and the silicon-containing material. One reason for this is that upon an electrode reaction (charging and discharging) of the secondary battery including the negative electrode 100, damage to the negative electrode active material layer 120 is suppressed while a battery capacity is secured.

In more detail, while the silicon-containing material as the metal-based material has an advantage of having a high theoretical capacity, there is a concern that the silicon-containing material can easily and greatly expand and contract upon charging and discharging. In contrast, while there is a concern that the carbon material has a low theoretical capacity, the carbon material has an advantage of not easily expanding and contracting upon charging and discharging. Thus, the combined use of the carbon material and the silicon-containing material suppresses expansion and contraction of the negative electrode active material layer 120 upon charging and discharging while achieving a high theoretical capacity. This suppresses the damage to the negative electrode active material layer 120 while the battery capacity is secured, as described above. Specific examples of the damage to the negative electrode active material layer 120 include cleaving of the negative electrode active material layer 120 and detachment of the negative electrode active material layer 120.

As described above, the alkali metal carbonic acid compound is included in the negative electrode active material layer 120. Accordingly, the alkali metal carbonic acid compound is dispersed in the negative electrode active material layer 120.

The alkali metal carbonic acid compound has a carbonate bond (—OC(═O)O—), and includes an alkali metal element as a constituent element. The number of carbonate bonds may be only one, or two or more. Specific examples of the alkali metal element include lithium, sodium, and potassium, as described above. Note that only one alkali metal carbonic acid compound may be used, or two or more alkali metal carbonic acid compounds may be used.

One reason why the negative electrode active material layer 120 includes the alkali metal carbonic acid compound is that a favorable film is formed on a surface of the negative electrode active material upon charging and discharging. The film is derived from the alkali metal carbonic acid compound, and has a high-density fine pore structure. Thus, the film covers the surface of the negative electrode active material having high reactivity to thereby protect the surface of the negative electrode active material. The film therefore has a function, i.e., a barrier function, of protecting the surface of the negative electrode active material from the electrolytic solution, while securing insertion and extraction of lithium into and from the negative electrode active material. Further, the film expands and contracts in accordance with the expansion and the contraction of the negative electrode active material during charging and discharging to thereby enhance physical strength of the negative electrode active material. The film therefore has a function, i.e., a stress relaxation function, of suppressing the damage to the negative electrode active material.

The alkali metal carbonic acid compound is not particularly limited in kind, and preferably includes any one or more of lithium carbonate (Li₂CO₃), a first alkali metal carbonic acid compound, or a second alkali metal carbonic acid compound, in particular. One reason for this is that this makes it easier for the film derived from the alkali metal carbonic acid compound to be formed stably.

The first alkali metal carbonic acid compound includes any one or more of compounds represented by Formula (1). As is apparent from Formula (1), the first alkali metal carbonic acid compound has one carbonate bond.

R1—OC(═O)O—M1 (1)
where:
R1 is an alkyl group; and
M1 is an alkali metal element.

The alkyl group is not particularly limited in kind, and specific examples thereof include a methyl group, an ethyl group, and a propyl group. Note that the alkyl group may have a straight-chain structure or may have a branched structure. Details of the alkali metal element are as described above.

Specific examples of the first alkali metal carbonic acid compound include lithium methyl carbonate (H₃C—OC(═O)O—Li), lithium ethyl carbonate (H₅C₂—OC(═O)O—Li), lithium propyl carbonate (H₇C₃—OC(═O)O—Li), sodium methyl carbonate (H₃C—OC(═O)O—Na), sodium ethyl carbonate (H₅C₂—OC(═O)O—Na), sodium propyl carbonate (H₇C₃—OC(═O)O—Na), potassium methyl carbonate (H₃C—OC(═O)O—K), potassium ethyl carbonate (H₅C₂—OC(═O)O—K), and potassium propyl carbonate (H₇C₃—OC(═O)O—K).

The second alkali metal carbonic acid compound includes any one or more of compounds represented by Formula (2). As is apparent from Formula (2), the second alkali metal carbonic acid compound has two carbonate bonds.

M2—OC(═O)O—R2—OC(═O)O—M3 (2)
where:
R2 is an alkylene group; and
each of M2 and M3 is an alkali metal element.

The alkylene group is not particularly limited in kind, and specific examples thereof include a methylene group, an ethylene group, and a propylene group. Note that the alkylene group may have a straight-chain structure or may have a branched structure. Details of the alkali metal element are as described above.

Specific examples of the second alkali metal carbonic acid compound include dilithium methylene dicarbonate (Li—OC(═O)O—CH₂—OC(═O)O—Li), dilithium ethylene dicarbonate (Li—OC(═O)O—C₂H₄—OC(═O)O—Li), dilithium propylene dicarbonate (Li—OC(═O)O—C₃H₆—OC(═O)O—Li), disodium methylene dicarbonate (Na—OC(═O)O—CH₂—OC(═O)O—Na), disodium ethylene dicarbonate (Na—OC(═O)O—C₂H₄—OC(═O)O—Na), disodium propylene dicarbonate (Na—OC(═O)O—C₃H₆—OC(=O)O—Na), dipotassium methylene dicarbonate (K—OC(═O)O—CH₂—OC(═O)O—K), dipotassium ethylene dicarbonate (K—OC(═O)O—C₂H₄—OC(═O)O—K), and dipotassium propylene dicarbonate (K—OC(═O)O—C₃H₆—OC(═O)O—K).

In particular, in the first alkali metal carbonic acid compound represented by Formula (1), the alkali metal element (M1) is preferably lithium, and in the second alkali metal carbonic acid compound represented by Formula (2), each of the alkali metal elements (M2 and M3) is preferably lithium. One reason for this is that this makes it easier for the film derived from the alkali metal carbonic acid compound to be formed stably.

A content of the alkali metal carbonic acid compound in the negative electrode active material layer 120 is not particularly limited, and is preferably within a range from 0.2 wt % to 0.8 wt % both inclusive, in particular. One reason for this is that this makes it easier for the film derived from the alkali metal carbonic acid compound to be formed stably.

When the negative electrode active material layer 120 includes two or more alkali metal carbonic acid compounds, the “content of the alkali metal carbonic acid compound in the negative electrode active material layer 120” as used herein refers to a sum total of the respective contents of the alkali metal carbonic acid compounds.

A procedure of checking whether the alkali metal carbonic acid compound is included in the negative electrode active material layer 120 and a procedure of calculating the content of the alkali metal carbonic acid compound in the negative electrode active material layer 120 are as described below.

First, the negative electrode current collector 110 is peeled off from the negative electrode active material layer 120 of the negative electrode 100 to thereby collect the negative electrode active material layer 120. When using the secondary battery including the negative electrode 100, the secondary battery is disassembled to thereby collect the negative electrode 100.

Thereafter, the negative electrode active material layer 120 is washed with a solvent for washing, following which the negative electrode active material layer 120 is dried. The solvent for washing is not particularly limited in kind, and is specifically an organic solvent such as acetone. An environmental condition at the time of drying is not particularly limited, and may specifically be an atmosphere of an inert gas such as an argon gas, or may be a dry environment.

Thereafter, the negative electrode active material layer 120 is put into a solution for extraction to thereby perform an extraction process (for an extraction time of 15 minutes). The solution for extraction is not particularly limited in kind, and specific examples thereof include a dimethyl sulfoxide-d₆ solution (LiTFSI DMSO-d₆) of lithium bis(trifluoromethanesulfonyl)imide (LiN(CF₃SO₂)₂). As a result, an extract is obtained.

Thereafter, the extract is analyzed using a nuclear magnetic resonance method. Here, a proton nuclear magnetic resonance method (¹H NMR) and a carbon-13 nuclear magnetic resonance method (¹³C NMR) are each used as the nuclear magnetic resonance method. If a peak attributed to the alkali metal carbonic acid compound is detected as a result of the analysis, it is confirmed that the alkali metal carbonic acid compound is included in the negative electrode active material layer 120.

For example, when the alkali metal carbonic acid compound includes the first alkali metal carbonic acid compound (lithium ethylene carbonate), peaks are detected at 3.44 ppm and 3.72 ppm by the proton nuclear magnetic resonance method and peaks are detected at 61.0 ppm, 65.8 ppm, and 156.9 ppm by the carbon-13 nuclear magnetic resonance method.

Further, when the alkali metal carbonic acid compound includes the second alkali metal carbonic acid compound (dilithium ethylene dicarbonate), a peak is detected at 3.63 ppm by the proton nuclear magnetic resonance method and peaks are detected at 62.7 ppm and 166.2 ppm by the carbon-13 nuclear magnetic resonance method.

Thereafter, when the alkali metal carbonic acid compound is included in the negative electrode active material layer 120, a weight of a partial structure (the alkali metal carbonic acid compound) in the extract is calculated by comparing an integrated value of a signal corresponding to a partial structure of an organic film component with an integrated value of a signal of an internal standard substance. The internal standard substance is not particularly limited in kind, and specific examples thereof include sodium 3-trimethylsilyl propionate-d₄.

Lastly, the content of the alkali metal carbonic acid compound in the negative electrode active material layer 120 is calculated based on a weight of the negative electrode active material layer 120 and the weight of the alkali metal carbonic acid compound. In this case, the following calculation expression is used: content (wt %) of alkali metal carbonic acid compound in negative electrode active material layer 120=(weight of alkali metal carbonic acid compound/weight of negative electrode active material layer 120)×100.

Note that in order to check whether the alkali metal carbonic acid compound is included in the negative electrode active material layer 120, infrared spectroscopy may be used instead of the nuclear magnetic resonance method.

For example, when the alkali metal carbonic acid compound includes the second alkali metal carbonic acid compound (dilithium ethylene dicarbonate), a peak is detected at each of 1650 cm⁻¹, 1395 cm⁻¹, 1305 cm⁻¹, 1080 cm⁻¹, and 820 cm⁻¹.

As described above, the magnesium compound is included in the negative electrode active material layer 120. Accordingly, the magnesium compound is dispersed in the negative electrode active material layer 120. Thus, the alkali metal carbonic acid compound and the magnesium compound are mixed with each other and dispersed in the negative electrode active material layer 120.

The magnesium compound includes magnesium as a constituent element. An element other than magnesium included in the magnesium compound is not particularly limited in kind, and may be chosen as desired. Note that only one magnesium compound may be used, or two or more magnesium compounds may be used.

One reason why the negative electrode active material layer 120 includes the magnesium compound together with the alkali metal carbonic acid compound is that the magnesium compound works self-sacrificingly upon charging and discharging, which allows the magnesium compound to react and decompose more preferentially than the alkali metal carbonic acid compound. This suppresses, with use of the magnesium compound, a reaction and a decomposition of the alkali metal carbonic acid compound. Accordingly, it becomes easier for the film derived from the alkali metal carbonic acid compound to be formed stably and continuously even upon repeated charging and discharging, which makes it easier to maintain the functions (the barrier function and the stress relaxation function) of the film.

The magnesium compound is not particularly limited in kind, and specific examples thereof include magnesium fluoride (MgF₂), magnesium oxide (MgO), magnesium nitride (Mg₃N₂), and magnesium carbonate (MgCO₃). One reason for this is that the reaction and the decomposition of the alkali metal carbonic acid compound is sufficiently and easily suppressed, which helps to sufficiently and easily maintain the functions of the film.

Note that the magnesium compound may already be included in the negative electrode active material layer 120 prior to initial charging and discharging of the secondary battery.

Alternatively, the magnesium compound may not yet be included in the negative electrode active material layer 120 prior to the initial charging and discharging of the secondary battery, and may be included in the negative electrode active material layer 120 only after the charging and discharging of the secondary battery. That is, the magnesium compound is not yet present in the negative electrode active material layer 120 prior to the initial charging and discharging; however, after the initial charging and discharging, the magnesium compound may be formed inside the negative electrode active material layer 120 through charging and discharging reactions, and may thus be present in the negative electrode active material layer 120.

A material that may be used to form the magnesium compound by the charging and discharging reactions is not particularly limited in kind, and specific examples thereof include magnesium nitrate (Mg(NO₃)₂) and magnesium carbonate (Mg(CO₃)₂).

A content of the magnesium compound in the negative electrode active material layer 120 is not particularly limited, and is preferably within a range from 0.01 wt % to 5 wt % both inclusive, in particular. One reason for this is that the reaction and the decomposition of the alkali metal carbonic acid compound is sufficiently and easily suppressed, which helps to sufficiently and easily maintain the functions of the film.

When the negative electrode active material layer 120 includes two or more magnesium compounds, the “content of the magnesium compound in the negative electrode active material layer 120” as used herein refers to a sum total of the respective contents of the magnesium compounds.

A procedure of checking whether the magnesium compound is included in the negative electrode active material layer 120 and a procedure of calculating the content of the magnesium compound in the negative electrode active material layer 120 are as described below.

First, the negative electrode current collector 110 is peeled off from the negative electrode active material layer 120 of the negative electrode 100 to thereby collect the negative electrode active material layer 120. When using the secondary battery including the negative electrode 100, the secondary battery is disassembled to thereby collect the negative electrode 100.

Thereafter, the negative electrode active material layer 120 is washed with a solvent for washing, following which the negative electrode active material layer 120 is dried naturally. The solvent for washing is not particularly limited in kind, and is specifically an organic solvent such as dimethyl carbonate. An environmental condition at the time of drying is not particularly limited, and is specifically an inside of a glove box into which an inert gas such as an argon gas is introduced.

Thereafter, a sample for analysis is prepared using an electrically conductive carbon double-sided tape (electrically conductive carbon double-sided tape (8 mm×20 m) Cat. No. 7311 available from Nisshin EM Co., Ltd.), following which the sample is moved from the inside of the glove box to an inside of an X-ray photoelectron spectroscopy (XPS) device. In this case, the sample is introduced into the inside of the XPS device with the sample not being exposed to the atmosphere.

Thereafter, the sample is analyzed using the XPS device. If a peak derived from the magnesium compound is detected as a result of the analysis, it is confirmed that the magnesium compound is included in the negative electrode active material layer 120.

For example, when the magnesium compound includes magnesium oxide, a peak is detected at or near a binding energy of about 50.4 eV, and when the magnesium compound is magnesium fluoride, a peak is detected at or near a binding energy of about 50.9 eV.

Note that usable as the XPS device is, for example, X-ray photoelectron spectrometer PHI 5000 VersaProbe available from ULVAC-PHI, Inc. Analysis conditions are as follows: X-ray source, monochromatic Al—Kα ray (1486.6 eV); X-ray spot diameter, 100 μmφ; photoelectron escape angle, 45°; and charge neutralization, neither electron gun (flood gun) nor Ar-ion gun is used.

Thereafter, when the magnesium compound is included in the negative electrode active material layer 120, a ratio between an area of a peak derived from the magnesium compound normalized based on a relative sensitivity and an area of a peak derived from each element included in the negative electrode active material layer 120 is calculated to thereby calculate a weight of the magnesium compound, based on the ratio.

Lastly, the content of the magnesium compound in the negative electrode active material layer 120 is calculated based on the weight of the negative electrode active material layer 120 and the weight of the magnesium compound. In this case, the following calculation expression is used: content (wt %) of magnesium compound in negative electrode active material layer 120=(weight of magnesium compound/weight of negative electrode active material layer 120)×100.

The negative electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The negative electrode conductor includes any one or more of electrically conductive materials including, without limitation, a carbon material. Specific examples of the electrically conductive material include graphite, carbon black, acetylene black, and Ketjen black. Note, however, that the electrically conductive material is not limited to the carbon material, and may be a metal material or a polymer compound, for example.

In the negative electrode 100, lithium is inserted into and extracted, in an ionic state, from the negative electrode active material in the negative electrode active material layer 120 upon the electrode reaction.

In manufacturing the negative electrode 100, first, the negative electrode active material, the alkali metal carbonic acid compound, and the magnesium compound are mixed with each other to thereby obtain a negative electrode mixture. In this case, the negative electrode mixture may include, for example, the negative electrode binder or the negative electrode conductor on an as-needed basis.

Thereafter, the negative electrode mixture is put into a solvent to thereby prepare a negative electrode mixture slurry in paste form. The solvent is not particularly limited in kind, and may therefore be an aqueous solvent or an organic solvent. In this case, the solvent with the negative electrode mixture put thereinto may be stirred using a stirring apparatus such as a mixer.

Here, the negative electrode mixture including the negative electrode active material, the alkali metal carbonic acid compound, and the magnesium compound is prepared, following which the negative electrode mixture slurry is prepared using the negative electrode mixture. Alternatively, the negative electrode mixture including the negative electrode active material may be prepared to thereby prepare the negative electrode mixture slurry using the negative electrode mixture, following which the alkali metal carbonic acid compound and the magnesium compound may be added to the negative electrode mixture slurry.

Lastly, the negative electrode mixture slurry is applied on the two opposed surfaces of the negative electrode current collector 110 to thereby form the negative electrode active material layers 120. Thereafter, the negative electrode active material layers 120 may be compression-molded by, for example, a roll pressing machine. In this case, the negative electrode active material layers 120 may be heated. The negative electrode active material layers 120 may be compression-molded multiple times.

In this manner, the negative electrode active material layers 120 are formed on the respective two opposed surfaces of the negative electrode current collector 110. Thus, the negative electrode 100 is completed.

According to the negative electrode 100, the negative electrode active material layer 120 includes the alkali metal carbonic acid compound and the magnesium compound.

In this case, the negative electrode active material layer 120 includes the alkali metal carbonic acid compound, and thus, a favorable film derived from the alkali metal carbonic acid compound is formed on the surface of the negative electrode active material upon charging and discharging of the secondary battery including the negative electrode 100, as described above. Accordingly, with use of the barrier function of the film, a decomposition reaction of the electrolytic solution on the surface of the negative electrode active material is suppressed while insertion and extraction of lithium are secured. Further, with use of the stress relaxation function of the film, the damage to the negative electrode active material attributed to the expansion and the contraction is suppressed.

Moreover, the negative electrode active material layer 120 includes the magnesium compound together with the alkali metal carbonic acid compound, which allows the magnesium compound to react and decompose more preferentially than the alkali metal carbonic acid compound upon charging and discharging, as described above. Accordingly, the reaction and the decomposition of the alkali metal carbonic acid compound is suppressed. Thus, it becomes easier for the film derived from the alkali metal carbonic acid compound to be formed stably and continuously even upon repeated charging and discharging, which makes it easier to maintain the functions (the barrier function and the stress relaxation function) of the film. Therefore, the decomposition reaction of the electrolytic solution on the surface of the negative electrode active material is suppressed continuously, and the damage to the negative electrode active material attributed to the expansion and the contraction is suppressed continuously.

Based upon the foregoing, a reduction in discharge capacity is suppressed even upon repeated charging and discharging. It is therefore possible to achieve a superior battery characteristic in the secondary battery including the negative electrode 100.

In particular, the alkali metal carbonic acid compound may include any one or more of lithium carbonate, the first alkali metal carbonic acid compound, or the second alkali metal carbonic acid compound. This makes it easier for the film derived from the alkali metal carbonic acid compound to be formed stably. Accordingly, it is possible to achieve higher effects.

In this case, in Formula (1) that represents the first alkali metal carbonic acid compound, the alkali metal element (M1) may include lithium, and in Formula (2) that represents the second alkali metal carbonic acid compound, each of the alkali metal elements (M2 and M3) may include lithium. This makes it easier for the film derived from the alkali metal carbonic acid compound to be formed stably. Accordingly, it is possible to achieve higher effects.

Further, the magnesium compound may include any one or more of magnesium fluoride, magnesium oxide, magnesium nitride, or magnesium carbonate. This helps to sufficiently and easily suppress the reaction and the decomposition of the alkali metal carbonic acid compound. As a result, the functions of the film are sufficiently and easily maintained. Accordingly, it is possible to achieve higher effects.

Further, the content of the alkali metal carbonic acid compound in the negative electrode active material layer 120 may be within the range from 0.2 wt % to 0.8 wt % both inclusive. This makes it easier for the film derived from the alkali metal carbonic acid compound to be formed stably. Accordingly, it is possible to achieve higher effects.

Further, the content of the magnesium compound in the negative electrode active material layer 120 may be within the range from 0.01 wt % to 5 wt % both inclusive. This helps to sufficiently and easily suppress the reaction and the decomposition of the alkali metal carbonic acid compound. As a result, the functions of the film are sufficiently and easily maintained. Accordingly, it is possible to achieve higher effects.

Further, the negative electrode active material layer 120 may include the negative electrode active material, and the negative electrode active material may include the carbon material and the silicon-containing material. This suppresses the damage to the negative electrode active material layer 120 while the battery capacity is secured. Accordingly, it is possible to achieve higher effects.

A description is given next of a secondary battery according to an embodiment of the present technology to which the negative electrode 100 is to be applied.

The secondary battery to be described here is a secondary battery in which a battery capacity is obtained through insertion and extraction of an electrode reactant, and includes a positive electrode, a negative electrode, and an electrolytic solution.

A charge capacity of the negative electrode is preferably greater than a discharge capacity of the positive electrode. In other words, an electrochemical capacity per unit area of the negative electrode is preferably greater than an electrochemical capacity per unit area of the positive electrode. This is to suppress precipitation of the electrode reactant on a surface of the negative electrode during charging.

Examples are given below of a case where the electrode reactant is lithium as in the description given above. A secondary battery in which the battery capacity is obtained through insertion and extraction of lithium is what is called a lithium-ion secondary battery. In the lithium-ion secondary battery, lithium is inserted and extracted in an ionic state.

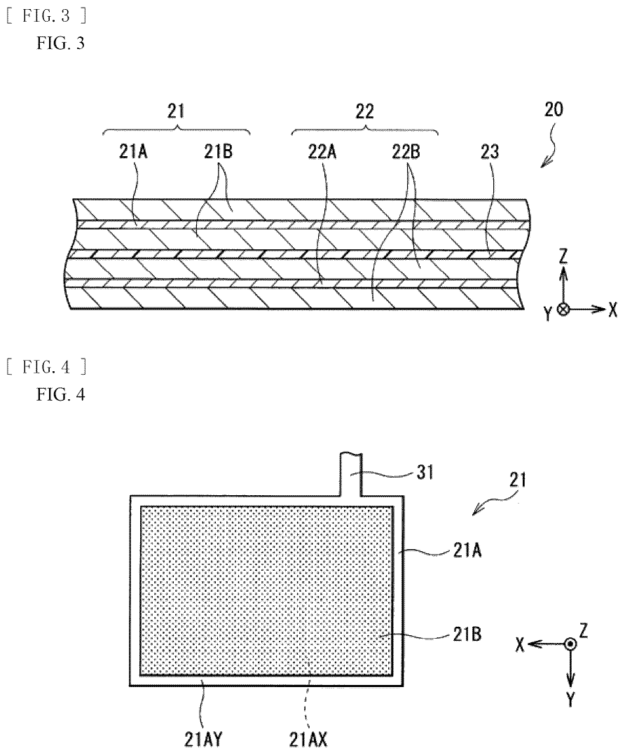

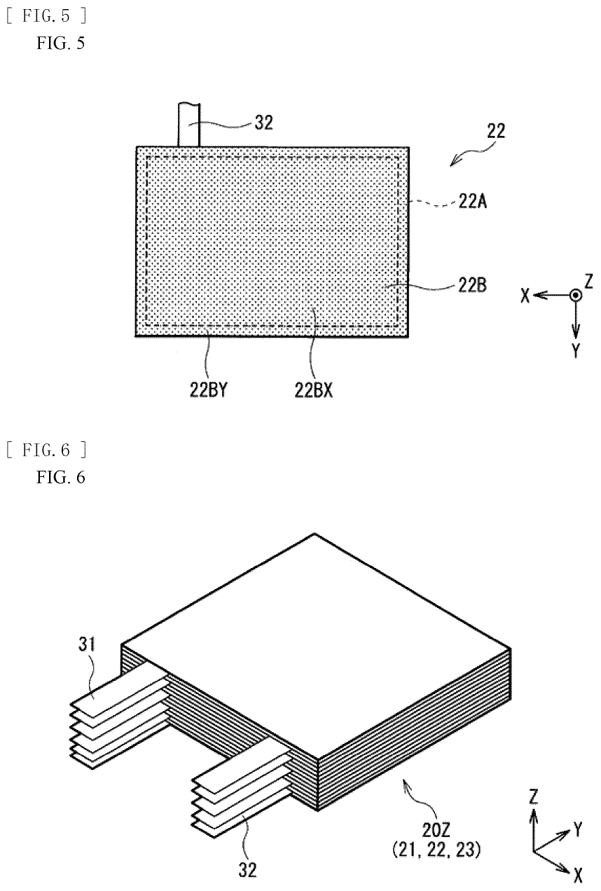

FIG. 2 illustrates a perspective configuration of the secondary battery. FIG. 3 illustrates a sectional configuration of a battery device 20 illustrated in FIG. 2. FIG. 4 illustrates a planar configuration of a positive electrode 21 illustrated in FIG. 3. FIG. 5 illustrates a planar configuration of a negative electrode 22 illustrated in FIG. 3. Note that FIG. 2 illustrates a state where an outer package film 10 and the battery device 20 are separated from each other.

As illustrated in FIGS. 2 and 3, the secondary battery includes the outer package film 10, the battery device 20, multiple positive electrode terminals 31, multiple negative electrode terminals 32, a positive electrode lead 41, a negative electrode lead 42, and sealing films 51 and 52.

The secondary battery to be described here includes the outer package film 10 having flexibility or softness as an outer package member, as described above. Accordingly, the secondary battery is what is called a secondary battery of a laminated-film type.

As illustrated in FIG. 2, the outer package film 10 is the outer package member that contains the battery device 20. The outer package film 10 has a pouch-shaped structure that is sealed in a state where the battery device 20 is contained inside the outer package film 10. The outer package film 10 thus contains the positive electrode 21, the negative electrode 22, and the electrolytic solution that are to be described later.

Here, the outer package film 10 is a single film-shaped member and is folded in a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

As illustrated in FIGS. 2 to 5, the battery device 20 is a power generation device that includes the positive electrode 21, the negative electrode 22, a separator 23, and the electrolytic solution (not illustrated). The battery device 20 is contained inside the outer package film 10.

Here, the battery device 20 is what is called a stacked electrode body, and the positive electrodes 21 and the negative electrodes 22 are alternately stacked on each other with separators 23 each interposed between corresponding one of the positive electrodes 21 and corresponding one of the negative electrodes 22. The respective numbers of the positive electrodes 21, the negative electrodes 22, and the separators 23 are not particularly limited, and may be set as desired.

The positive electrode 21 includes, as illustrated in FIGS. 3 and 4, a positive electrode current collector 21A and a positive electrode active material layer 21B. In FIG. 4, the positive electrode active material layer 21B is shaded.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

The positive electrode active material layer 21B includes any one or more of positive electrode active materials into which lithium is to be inserted and from which lithium is to be extracted. Note that the positive electrode active material layer 21B may further include any one or more of other materials including, without limitation, a positive electrode binder and a positive electrode conductor.

Here, the positive electrode active material layer 21B is provided on each of the two opposed surfaces of the positive electrode current collector 21A. Note that the positive electrode active material layer 21B may be provided only on one of the two opposed surfaces of the positive electrode current collector 21A on a side where the positive electrode 21 is opposed to the negative electrode 22. A method of forming the positive electrode active material layer 21B is not particularly limited, and specifically includes a method such as the coating method.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically, for example, an oxide, a phosphoric acid compound, a silicic acid compound, or a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

Details of the positive electrode binder are similar to those of the negative electrode binder described above. Details of the positive electrode conductor are similar to those of the negative electrode conductor described above.

Here, as illustrated in FIG. 4, a portion of the positive electrode current collector 21A protrudes. The positive electrode current collector 21A therefore includes a part protruding toward an outer side relative to the positive electrode active material layer 21B. Hereinafter, the part is referred to as a “protruding part of the positive electrode current collector 21A”. The protruding part of the positive electrode current collector 21A is not provided with the positive electrode active material layer 21B, and therefore serves as the positive electrode terminal 31. Note that details of the positive electrode terminal 31 will be described later.

The positive electrode active material layer 21B is provided only on a portion of the positive electrode current collector 21A on each of the two opposed surfaces (excluding the positive electrode terminal 31) of the positive electrode current collector 21A. Accordingly, a part, of the positive electrode current collector 21A, on which the positive electrode active material layer 21B is not provided is exposed without being covered with the positive electrode active material layer 21B.

Specifically, the positive electrode current collector 21A includes a covered part 21AX and an uncovered part 21AY as illustrated in FIG. 4. The covered part 21AX is positioned at a middle part of the positive electrode current collector 21A and is a part on which the positive electrode active material layer 21B is provided. The uncovered part 21AY is positioned around the covered part 21AX and is a part having a frame shape on which the positive electrode active material layer 21B is not provided. Accordingly, the covered part 21AX is covered with the positive electrode active material layer 21B, whereas the uncovered part 21AY is exposed without being covered with the positive electrode active material layer 21B.

The negative electrode 22 has a configuration similar to that of the negative electrode 100 described above. Specifically, the negative electrode 22 includes, as illustrated in FIGS. 3 and 5, a negative electrode current collector 22A and a negative electrode active material layer 22B. In FIG. 5, the negative electrode active material layer 22B is shaded.

The negative electrode current collector 22A has a configuration similar to that of the negative electrode current collector 110, and the negative electrode active material layer 22B has a configuration similar to that of the negative electrode active material layer 120. That is, the negative electrode active material layer 22B includes the alkali metal carbonic acid compound and the magnesium compound.

Here, as illustrated in FIG. 5, a portion of the negative electrode current collector 22A protrudes. The negative electrode current collector 22A therefore includes a part protruding toward the outer side relative to the negative electrode active material layer 22B. Hereinafter, the part is referred to as a “protruding part of the negative electrode current collector 22A”.

The protruding part of the negative electrode current collector 22A protrudes in a direction similar to that in which the protruding part of the positive electrode current collector 21A protrudes. The protruding part of the negative electrode current collector 22A is positioned at a position not overlapping the protruding part of the positive electrode current collector 21A in a state in which the positive electrodes 21 and the negative electrodes 22 are alternately stacked with the separators 23 each interposed between corresponding one of the positive electrodes 21 and corresponding one of the negative electrodes 22.

The protruding part of the negative electrode current collector 22A is not provided with the negative electrode active material layer 22B, and therefore serves as the negative electrode terminal 32. Note that details of the negative electrode terminal 32 will be described later.

The negative electrode active material layer 22B is provided on the entire negative electrode current collector 22A, on each of the two opposed surfaces (excluding the negative electrode terminal 32) of the negative electrode current collector 22A. Accordingly, the negative electrode current collector 22A is entirely covered with the negative electrode active material layers 22B without being exposed.

Specifically, the negative electrode active material layer 22B includes, as illustrated in FIG. 5, an opposed part 22BX and a non-opposed part 22BY. The opposed part 22BX is opposed to the covered part 21AX. That is, the opposed part 22BX is opposed to the positive electrode active material layer 21B and thus contributes to the charging and discharging reactions. The non-opposed part 22BY is opposed to the uncovered part 21AY. That is, the non-opposed part 22BY is not opposed to the positive electrode active material layer 21B, is opposed to the positive electrode current collector 21A, and thus does not contribute to the charging and discharging reactions. In FIG. 5, in order to make a formation range of the covered part 21AX (the positive electrode active material layer 21B) easy to understand, the formation range of the covered part 21AX (a border between the opposed part 22BX and the non-opposed part 22BY) is indicated by a dashed line.

The negative electrode active material layer 22B is provided on an entire region of each of the two opposed surfaces of the negative electrode current collector 22A, whereas the positive electrode active material layer 21B is provided only on a portion (the covered part 21AX) of each of the two opposed surfaces of the positive electrode current collector 21A. This is to suppress precipitation of lithium extracted from the positive electrode active material layer 21B at the time of charging on the surface of the negative electrode 22.

As illustrated in FIG. 3, the separator 23 is an insulating porous film interposed between the positive electrode 21 and the negative electrode 22, and allows a lithium ion to pass therethrough while preventing contact (a short circuit) between the positive electrode 21 and the negative electrode 22. The separator 23 includes a polymer compound such as polyethylene.

The electrolytic solution is a liquid electrolyte. The positive electrode 21, the negative electrode 22, and the separator 23 are each impregnated with the electrolytic solution. The electrolytic solution includes a solvent and an electrolyte salt.

Here, the solvent includes any one or more of non-aqueous solvents (organic solvents), and the electrolytic solution including the non-aqueous solvent(s) is what is called a non-aqueous electrolytic solution. The non-aqueous solvent includes, for example, an ester or an ether, more specifically, a carbonic-acid-ester-based compound, a carboxylic-acid-ester-based compound, or a lactone-based compound, for example. One reason for this is that a dissociation property of the electrolyte salt improves and mobility of ions also improves.

The carbonic-acid-ester-based compound is, for example, a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate.

The lactone-based compound is, for example, a lactone. Specific examples of the lactone include γ-butyrolactone and γ-valerolactone.

Note that the ether may be, for example, 1,2-dimethoxyethane, tetrahydrofuran, 1,3-dioxolane, or 1,4-dioxane.

The electrolyte salt includes any one or more of light metal salts including, without limitation, a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). One reason for this is that a high battery capacity is obtainable.

A content of the electrolyte salt is not particularly limited, and is specifically within a range from 0.3 mol/kg to 3.0 mol/kg both inclusive with respect to the solvent. One reason for this is that high ion conductivity is obtainable.

Note that the electrolytic solution may further include any one or more of additives. The additives are not particularly limited in kind, and specific examples thereof include an unsaturated cyclic carbonic acid ester, a fluorinated cyclic carbonic acid ester, a sulfonic acid ester, a phosphoric acid ester, an acid anhydride, a nitrile compound, and an isocyanate compound.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The positive electrode terminal 31 is electrically coupled to the positive electrode 21, as illustrated in FIG. 4. More specifically, the positive electrode terminal 31 is electrically coupled to the positive electrode current collector 21A. In the battery device 20, as described above, the positive electrodes 21 and the negative electrodes 22 are alternately stacked on each other with the separators 23 each interposed between corresponding one of the positive electrodes 21 and corresponding one of the negative electrodes 22. Accordingly, the battery device 20 includes the multiple positive electrodes 21. Thus, the secondary battery includes the multiple positive electrode terminals 31.

The positive electrode terminals 31 each include an electrically conductive material such as a metal material. The electrically conductive material is not particularly limited in kind. Specifically, the positive electrode terminals 31 each include a material similar to the material included in the positive electrode current collector 21A.

Here, as described above, the protruding part of the positive electrode current collector 21A serves as the positive electrode terminal 31. Accordingly, the positive electrode terminal 31 is physically integrated with the positive electrode current collector 21A. One reason for this is that coupling resistance between the positive electrode current collector 21A and the positive electrode terminal 31 decreases, and electric resistance of the entire secondary battery therefore decreases.

As will be described later, the multiple positive electrode terminals 31 are joined to each other by a joining method such as a welding method to thereby form one joint part 31Z having a lead shape, as illustrated in FIG. 2.

The negative electrode terminal 32 is electrically coupled to the negative electrode 22, as illustrated in FIG. 5. More specifically, the negative electrode terminal 32 is electrically coupled to the negative electrode current collector 22A. In the battery device 20, as described above, the positive electrodes 21 and the negative electrodes 22 are alternately stacked on each other with the separators 23 each interposed between corresponding one of the positive electrodes 21 and corresponding one of the negative electrodes 22. Accordingly, the battery device 20 includes the multiple negative electrodes 22. Thus, the secondary battery 20 includes the multiple negative electrode terminals 32.

The negative electrode terminals 32 each include an electrically conductive material such as a metal material. The electrically conductive material is not particularly limited in kind. Specifically, the negative electrode terminals 32 each include a material similar to the material included in the negative electrode current collector 22A.

Here, as described above, the protruding part of the negative electrode current collector 22A serves as the negative electrode terminal 32. Accordingly, the negative electrode terminal 32 is physically integrated with the negative electrode current collector 22A. One reason for this is that coupling resistance between the negative electrode current collector 22A and the negative electrode terminal 32 decreases, and the electric resistance of the entire secondary battery therefore decreases.

As will be described later, the multiple negative electrode terminals 32 are joined to each other by the joining method such as the welding method to thereby form one joint part 32Z having a lead shape, as illustrated in FIG. 2.

As illustrated in FIG. 2, the positive electrode lead 41 is coupled to the joint part 31Z, and is led to an outside of the outer package film 10. The positive electrode lead 41 includes an electrically conductive material such as a metal material. Specifically, the positive electrode lead 41 includes a material similar to the material included in the positive electrode current collector 21A. The positive electrode lead 41 is not particularly limited in shape, and specifically has any of shapes including, without limitation, a thin plate shape and a meshed shape.

As illustrated in FIG. 2, the negative electrode lead 42 is coupled to the joint part 32Z, and is led to an outside of the outer package film 10. The negative electrode lead 42 includes an electrically conductive material such as a metal material. Specifically, the negative electrode lead 42 includes a material similar to the material included in the negative electrode current collector 22A. Note that the negative electrode lead 42 is led in a direction similar to that in which the positive electrode lead 41 is led. Details of a shape of the negative electrode lead 42 are similar to those of the shape of the positive electrode lead 41.

The sealing film 51 is interposed between the outer package film 10 and the positive electrode lead 41. The sealing film 52 is interposed between the outer package film 10 and the negative electrode lead 42. Note that the sealing film 51, the sealing film 52, or both may be omitted.

The sealing film 51 is a sealing member that prevents entry, for example, of outside air into the outer package film 10. The sealing film 51 includes a polymer compound such as a polyolefin that has adherence to the positive electrode lead 41. Specific examples of the polymer compound include polypropylene.

A configuration of the sealing film 52 is similar to that of the sealing film 51 except that the sealing film 52 is a sealing member that has adherence to the negative electrode lead 42. That is, the sealing film 52 includes a polymer compound such as a polyolefin that has adherence to the negative electrode lead 42.

The secondary battery operates as described below.

Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. Upon the charging and discharging, lithium is inserted and extracted in an ionic state.

FIG. 6 illustrates a perspective configuration corresponding to FIG. 2, for describing a method of manufacturing the secondary battery. Note that FIG. 6 illustrates, in place of the battery device 20, a stacked body 20Z to be used to fabricate the battery device 20. Details of the stacked body 20Z will be described later.

In a case of manufacturing the secondary battery, the positive electrode 21 and the negative electrode 22 are each fabricated, and the electrolytic solution is prepared, following which the secondary battery is assembled using the positive electrode 21, the negative electrode 22, and the electrolytic solution, and a stabilization process of the secondary battery is performed, according to an example procedure to be described below. In the following, where appropriate, reference will be made to FIGS. 1 to 5 that have already been described.

First, a mixture (a positive electrode mixture) in which the positive electrode active material, the positive electrode binder, and the positive electrode conductor are mixed with each other is put into a solvent to thereby prepare a positive electrode mixture slurry in paste form. The solvent may be an aqueous solvent, or may be an organic solvent. Thereafter, the positive electrode mixture slurry is applied on the two opposed surfaces (excluding the positive electrode terminal 31) of the positive electrode current collector 21A integrated with the positive electrode terminal 31 to thereby form the positive electrode active material layers 21B. Lastly, the positive electrode active material layers 21B are compression-molded by, for example, a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The negative electrode 22 is formed by a procedure similar to the fabrication procedure of the negative electrode 100 described above. Specifically, first, a mixture (a negative electrode mixture) in which the negative electrode active material, the alkali metal carbonic acid compound, the magnesium compound, and the negative electrode binder are mixed with each other is put into a solvent to thereby prepare a negative electrode mixture slurry in paste form. Thereafter, the negative electrode mixture slurry is applied on the two opposed surfaces (excluding the negative electrode terminal 32) of the negative electrode current collector 22A integrated with the negative electrode terminal 32 to thereby form the negative electrode active material layers 22B. Lastly, the negative electrode active material layers 22B are compression-molded. The negative electrode active material layers 22B are thus formed on the two respective opposed surfaces of the negative electrode current collector 22A. As a result, the negative electrode 22 is fabricated.

The electrolyte salt is put into a solvent. The electrolyte salt is thereby dispersed or dissolved in the solvent. As a result, the electrolytic solution is prepared.

First, the positive electrodes 21 and the negative electrodes 22 are alternately stacked on each other with the separators 23 each interposed between corresponding one of the positive electrodes 21 and corresponding one of the negative electrodes 22 to thereby form the stacked body 20Z, as illustrated in FIG. 6. The stacked body 20Z has a configuration similar to the configuration of the battery device 20 except that the positive electrodes 21, the negative electrodes 22, and the separators 23 are each not impregnated with the electrolytic solution.

Thereafter, the multiple positive electrode terminals 31 are joined to each other by the joining method such as the welding method to thereby form the joint part 31Z, following which the positive electrode lead 41 is coupled to the joint part 31Z by the joining method such as the welding method. Further, the multiple negative electrode terminals 32 are joined to each other by the joining method such as the welding method to thereby form the joint part 32Z, following which the negative electrode lead 42 is coupled to the joint part 32Z by the joining method such as the welding method.

Thereafter, the stacked body 20Z is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the stacked body 20Z to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by the bonding method such as the thermal-fusion-bonding method. In this case, the sealing film 51 is interposed between the outer package film 10 and the positive electrode lead 41, and the sealing film 52 is interposed between the outer package film 10 and the negative electrode lead 42.

The stacked body 20Z is thereby impregnated with the electrolytic solution, and the battery device 20 that is a stacked electrode body is thus fabricated. Accordingly, the battery device 20 is sealed in the outer package film 10 having the pouch shape. As a result, the secondary battery is assembled.

The assembled secondary battery is charged and discharged. Various conditions including, for example, an environment temperature, the number of times of charging and discharging (the number of cycles), and charging and discharging conditions may be set as desired. As a result, a film is formed on the surface of each of the positive electrode 21 and the negative electrode 22, which electrochemically stabilizes a state of the secondary battery. As a result, the secondary battery is completed.

The secondary battery includes the negative electrode 22 having a configuration similar to that of the negative electrode 100. It is therefore possible to achieve a superior battery characteristic for the reason described above.

In particular, the secondary battery may include a lithium-ion secondary battery. This makes it possible to obtain a sufficient battery capacity stably through insertion and extraction of lithium. Accordingly, it is possible to achieve higher effects.

Other action and effects of the secondary battery are similar to those of the negative electrode 100 described above.

The configuration of each of the negative electrode 100 and the secondary battery described above is appropriately modifiable as described below according to an embodiment. Note that any two or more of the following series of modification examples may be combined with each other.

In FIG. 4, the protruding part of the positive electrode current collector 21A also serves as the positive electrode terminal 31. Accordingly, the positive electrode terminal 31 is physically integrated with the positive electrode current collector 21A. However, the positive electrode terminal 31 may be physically separated from the positive electrode current collector 21A, and the positive electrode terminal 31 may thus be provided separately from the positive electrode current collector 21A. In this case, the positive electrode terminal 31 may be coupled to the positive electrode current collector 21A by the joining method such as the welding method.

In this case also, the positive electrode terminal 31 is electrically coupled to the positive electrode 21, and similar effects are therefore obtainable. Note that, to reduce the coupling resistance and accordingly reduce the electric resistance of the entire secondary battery, the positive electrode terminal 31 is preferably physically integrated with the positive electrode current collector 21A.

Likewise, in FIG. 5, the protruding part of the negative electrode current collector 22A also serves as the negative electrode terminal 32. Accordingly, the negative electrode terminal 32 is physically integrated with the negative electrode current collector 22A. However, the negative electrode terminal 32 may be physically separated from the negative electrode current collector 22A, and the negative electrode terminal 32 may thus be provided separately from the negative electrode current collector 22A. In this case, the negative electrode terminal 32 may be coupled to the negative electrode current collector 22A by the joining method such as the welding method.

In this case also, the negative electrode terminal 32 is electrically coupled to the negative electrode 22, and similar effects are therefore obtainable. Note that, to reduce the coupling resistance and accordingly reduce the electric resistance of the entire secondary battery, the negative electrode terminal 32 is preferably physically integrated with the negative electrode current collector 22A.

In FIG. 2, the battery device 20 that is a stacked electrode body is used. However, although not specifically illustrated here, a battery device that is a wound electrode body may be used. In this case, the positive electrode 21 has a band-shaped structure, and the positive electrode terminal 31 is electrically coupled to the positive electrode current collector 21A. The negative electrode 22 has a band-shaped structure, and the negative electrode terminal 32 is electrically coupled to the negative electrode current collector 22A. The positive electrode 21 and the negative electrode 22 are thus wound, being opposed to each other with the separator 23 interposed therebetween. The number of positive electrode terminals 31 may be only one, or two or more. Likewise, the number of negative electrode terminals 32 may be only one, or two or more.

In this case also, the secondary battery is chargeable and dischargeable with use of the battery device 20, and similar effects are therefore obtainable.

The separator 23 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. One reason for this is that adherence of the separator to each of the positive electrode 21 and the negative electrode 22 improves to suppress misalignment of the battery device 20. This suppresses swelling of the secondary battery even if a side reaction such as the decomposition reaction of the electrolytic solution occurs. The polymer compound layer includes a polymer compound such as polyvinylidene difluoride. One reason for this is that superior physical strength and superior electrochemical stability are obtainable.

Note that the porous film, the polymer compound layer, or both may each include any one or more kinds of insulating particles. One reason for this is that the insulating particles promote heat dissipation upon heat generation by the secondary battery, thus improving safety or heat resistance of the secondary battery. The insulating particles include any one or more of insulating materials including, without limitation, an inorganic material and a resin material. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

When fabricating the separator of the stacked type, a precursor solution including, without limitation, the polymer compound and a solvent is prepared, following which the precursor solution is applied on one of or each of the two opposed surfaces of the porous film. In this case, insulating particles may be added to the precursor solution on an as-needed basis.

When the separator of the stacked type is used also, a lithium ion is movable between the positive electrode 21 and the negative electrode 22, and similar effects are therefore obtainable. In this case, in particular, the secondary battery improves in safety, as described above. Accordingly, it is possible to achieve higher effects.

The electrolytic solution, which is a liquid electrolyte, is used. However, although not specifically illustrated here, an electrolyte layer, which is a gel electrolyte, may be used.

In the battery device 20 including the electrolyte layer, the positive electrodes 21 and the negative electrodes 22 are alternately stacked on each other with the separators 23 and the electrolyte layers each interposed between corresponding one of the positive electrodes 21 and corresponding one of the negative electrodes 22. The electrolyte layers include the electrolyte layer interposed between the positive electrode 21 and the separator 23, and the electrolyte layer interposed between the negative electrode 22 and the separator 23.

Specifically, the electrolyte layer includes a polymer compound together with the electrolytic solution. The electrolytic solution is held by the polymer compound. One reason for this is that leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

When the electrolyte layer is used also, a lithium ion is movable between the positive electrode 21 and the negative electrode 22 via the electrolyte layer, and similar effects are therefore obtainable. In this case, in particular, the leakage of the electrolytic solution is prevented, as described above. Accordingly, it is possible to achieve higher effects.

Applications (application examples) of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, or may be switched from the main power source.

Specific examples of the applications of the secondary battery are as described below. The specific examples include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery packs may each include a battery cell, or may each include an assembled battery. The electric vehicle is a vehicle that travels with the secondary battery as a driving power source, and may be a hybrid automobile that is additionally provided with a driving source other than the secondary battery. In the electric power storage system for home use, electric power accumulated in the secondary battery serving as an electric power storage source may be utilized for using, for example, home appliances.

An application example of the secondary battery will now be described in detail. The configuration of the application example described below is merely an example, and is appropriately modifiable.

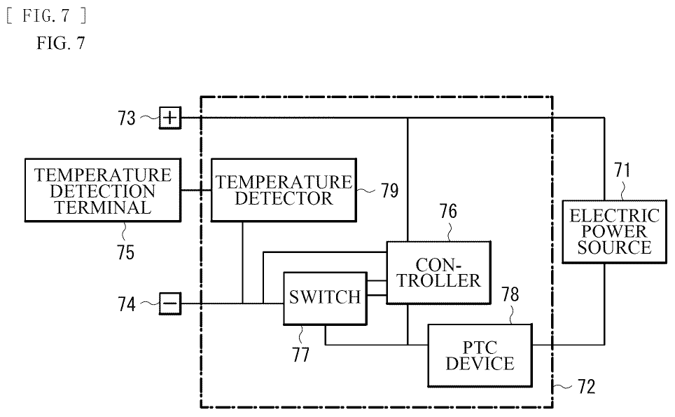

FIG. 7 illustrates a block configuration of a battery pack. The battery pack described here is a battery pack (what is called a soft pack) including one secondary battery, and is to be mounted on, for example, electronic equipment typified by a smartphone.

As illustrated in FIG. 7, the battery pack includes an electric power source 71 and a circuit board 72. The circuit board 72 is coupled to the electric power source 71, and includes a positive electrode terminal 73, a negative electrode terminal 74, and a temperature detection terminal 75.

The electric power source 71 includes one secondary battery. The secondary battery has a positive electrode lead coupled to the positive electrode terminal 73 and a negative electrode lead coupled to the negative electrode terminal 74. The electric power source 71 is couplable to outside via the positive electrode terminal 73 and the negative electrode terminal 74, and is thus chargeable and dischargeable. The circuit board 72 includes a controller 76, a switch 77, a thermosensitive resistive device (a PTC device) 78, and a temperature detector 79. However, the PTC device 78 may be omitted.

The controller 76 includes, for example, a central processing unit (CPU) and a memory, and controls an overall operation of the battery pack. The controller 76 detects and controls a use state of the electric power source 71 on an as-needed basis.

If a voltage of the electric power source 71 (the secondary battery) reaches an overcharge detection voltage or an overdischarge detection voltage, the controller 76 turns off the switch 77. This prevents a charging current from flowing into a current path of the electric power source 71. The overcharge detection voltage is not particularly limited, and is specifically 4.20 V±0.05 V. The overdischarge detection voltage is not particularly limited, and is specifically 2.40 V±0.1 V.

The switch 77 includes, for example, a charge control switch, a discharge control switch, a charging diode, and a discharging diode. The switch 77 performs switching between coupling and decoupling between the electric power source 71 and external equipment in accordance with an instruction from the controller 76. The switch 77 includes, for example, a metal-oxide-semiconductor field-effect transistor (MOSFET). The charging and discharging currents are detected based on an ON-resistance of the switch 77.

The temperature detector 79 includes a temperature detection device such as a thermistor. The temperature detector 79 measures a temperature of the electric power source 71 through the temperature detection terminal 75, and outputs a result of the temperature measurement to the controller 76. The result of the temperature measurement to be obtained by the temperature detector 79 is used, for example, when the controller 76 performs charge and discharge control upon abnormal heat generation or when the controller 76 performs a correction process upon calculating a remaining capacity.

### EXAMPLES

A description is given of Examples of the present technology according to an embodiment.

### Examples 1 to 17 and Comparative Examples 1 to 3

Secondary batteries were manufactured, following which the secondary batteries were each evaluated for a battery characteristic as described below.

### Manufacturing of Secondary Battery

The secondary batteries (the lithium-ion secondary batteries of the laminated-film type) illustrated in FIGS. 2 and 5 were manufactured in accordance with the following procedure.

### Fabrication of Positive Electrode

First, 94 parts by mass of a positive electrode active material (LiNi_{0.8}Co_{0.15}Al_{0.05}O₂ as a lithium-containing compound (an oxide)), 3 parts by mass of a positive electrode binder (polyvinylidene difluoride), and 3 parts by mass of a positive electrode conductor (Ketjen black as an amorphous carbon powder) were mixed with each other to thereby obtain a positive electrode mixture. Thereafter, the positive electrode mixture was put into a solvent (N-methyl-2-pyrrolidone as the organic solvent), following which the organic solvent was stirred to thereby prepare a positive electrode mixture slurry in paste form. Thereafter, the positive electrode mixture slurry was applied on the two opposed surfaces (excluding the positive electrode terminal 31) of the positive electrode current collector 21A (an aluminum foil having a thickness of 20 μm) integrated with the positive electrode terminal 31, by a coating apparatus, following which the applied positive electrode mixture slurry was dried to thereby form the positive electrode active material layers 21B. Lastly, the positive electrode active material layers 21B were compression-molded by a roll pressing machine. In this manner, the positive electrode 21 was fabricated.

### Fabrication of Negative Electrode

First, 60 parts by mass of a negative electrode active material (artificial graphite as a carbon material), 30 parts by mass of a negative electrode active material (silicon oxide (SiOₓ) as a silicon-containing material), and 10 parts by mass of a negative electrode binder (a styrene-butadiene rubber) were mixed with each other to thereby obtain a negative electrode mixture. Thereafter, the negative electrode mixture was put into a solvent (N-methyl-2-pyrrolidone as the organic solvent), following which the organic solvent was stirred to thereby prepare a negative electrode mixture slurry in paste form.

Thereafter, the alkali metal carbonic acid compound and the magnesium compound were added to the negative electrode mixture slurry, and the negative electrode mixture slurry was stirred.

Used as the alkali metal carbonic acid compound were lithium carbonate (Li₂CO₃), the first alkali metal carbonic acid compound, and the second alkali metal carbonic acid compound. Used as the first alkali metal carbonic acid compound were lithium methyl carbonate (LMC), lithium ethyl carbonate (LEC), and lithium propyl carbonate (LPC). Used as the second alkali metal carbonic acid compound were dilithium ethylene dicarbonate (LEDC) and dilithium propylene dicarbonate (LPDC).

Used as the magnesium compound were magnesium fluoride (MgF₂), magnesium oxide (MgO), magnesium nitride (Mg₃N₂), and magnesium carbonate (MgCO₃).

Here, as an example method of synthesizing the second alkali metal carbonic acid compound, a method of synthesizing dilithium ethylene dicarbonate is specifically described. When synthesizing dilithium ethylene dicarbonate, an organic solvent (ethylene carbonate) and a tetrahydrofuran solution of lithium naphthalenide were mixed with each other, following which the mixture was left to stand (for a leaving time of one day). As a result, ethylene carbonate and lithium naphthalenide reacted with each other, and dilithium ethylene dicarbonate was thus synthesized.

Thereafter, the negative electrode mixture slurry was applied on the two opposed surfaces (excluding the negative electrode terminal 32) of the negative electrode current collector 22A (a copper foil having a thickness of 15 μm) integrated with the negative electrode terminal 32, by a coating apparatus, following which the applied negative electrode mixture slurry was dried to thereby form the negative electrode active material layers 22B. Lastly, the negative electrode active material layers 22B were compression-molded by a roll pressing machine. In this manner, the negative electrode 22 was fabricated.

Note that, the negative electrode 22 for comparison was fabricated by a similar procedure, except that neither the alkali metal carbonic acid compound nor the magnesium compound was included. Further, the negative electrode 22 for comparison was fabricated by a similar procedure, except that either the alkali metal carbonic acid compound or the magnesium compound was included.

### Preparation of Electrolytic Solution

First, an electrolyte salt (LiPF₆) was put into a solvent, following which the solvent was stirred. Used as the solvent was a mixture of: ethylene carbonate and propylene carbonate as cyclic carbonic acid esters; dimethyl carbonate and ethyl methyl carbonate as chain carbonic acid esters; and monofluoroethylene carbonate as a fluorinated cyclic carbonic acid ester. A composition (a mass ratio) of the solvent between ethylene carbonate, propylene carbonate, dimethyl carbonate, ethyl methyl carbonate, and monofluoroethylene carbonate was set to 27.5:5:60:5:2.5. A content of the electrolyte salt was set to 1.5 mol/kg with respect to the solvent.

### Assembly of Secondary Battery

First, the positive electrodes 21 and the negative electrodes 22 were stacked on each other with the separators 23 (fine porous polyethylene films each having a thickness of 15 μm) each interposed between corresponding one of the positive electrodes 21 and corresponding one of the negative electrodes 22 to thereby fabricate the stacked body 20Z.

Thereafter, the multiple positive electrode terminals 31 were welded to each other to thereby form the joint part 31Z, following which the positive electrode lead 41 (an aluminum foil) was welded to the joint part 31Z. Further, the multiple negative electrode terminals 32 were welded to each other to thereby form the joint part 32Z, following which the negative electrode lead 42 (a copper foil) was welded to the joint part 32Z.

Thereafter, the outer package film 10 (a fusion-bonding layer/a metal layer/a surface protective layer) was so folded as to sandwich the stacked body 20Z placed in the depression part 10U. Thereafter, outer edge parts of two sides of the fusion-bonding layer were thermal-fusion-bonded to each other to thereby allow the stacked body 20Z to be contained inside the outer package film 10 having the pouch shape. As the outer package film 10, an aluminum laminated film was used in which the fusion-bonding layer (a polypropylene film having a thickness of 30 μm), the metal layer (an aluminum foil having a thickness of 40 μm), and the surface protective layer (a nylon film having a thickness of 25 μm) were stacked in this order from the inner side.

Lastly, the electrolytic solution was injected into the outer package film 10 having the pouch shape, following which outer edge parts of the remaining one side of the fusion-bonding layer were thermal-fusion-bonded to each other in a reduced-pressure environment. In this case, the sealing film 51 (a polypropylene film having a thickness of 5 μm) was interposed between the outer package film 10 and the positive electrode lead 41, and the sealing film 52 (a polypropylene film having a thickness of 5 μm) was interposed between the outer package film 10 and the negative electrode lead 42. The stacked body 20Z was thereby impregnated with the electrolytic solution, and the battery device 20 that was a stacked electrode body was thus fabricated.

Accordingly, the battery device 20 was sealed in the outer package film 10. As a result, the secondary battery was assembled.

After the completion of the secondary battery, the content (wt %) of the alkali metal carbonic acid compound in the negative electrode active material layer 120 and the content (wt %) of the magnesium compound in the negative electrode active material layer 120 were calculated. The results of the calculation were as presented in Table 1. Details of the calculation procedure were as described above.

### Stabilization of Secondary Battery

The secondary battery was charged and discharged for one cycle in an ambient temperature environment (at a temperature of 25° C.). Upon charging, the secondary battery was charged with a constant current of 0.1 C until a voltage reached 4.2 V, and was thereafter charged with a constant voltage of that value, 4.2 V, until a current reached 0.05 C. Upon discharging, the secondary battery was discharged with a constant current of 0.1 C until the voltage reached 2.5 V. Note that 0.1 C was a value of a current that caused a battery capacity (a theoretical capacity) to be completely discharged in 10 hours, and 0.05 C was a value of a current that caused the battery capacity to be completely discharged in 20 hours.

A film was thus formed on the surface of each of the positive electrode 21 and the negative electrode 22, and the state of the secondary battery was therefore electrochemically stabilized. As a result, the secondary battery of the laminated-film type was completed.

### Evaluation of Battery Characteristic

The secondary batteries were each evaluated for a cyclability characteristic as the battery characteristic, and the evaluation revealed the results presented in Table 1.

When evaluating the cyclability characteristic, first, the secondary battery was left to stand (for a standing time of 3 hours) in a low-temperature environment (at a temperature of 5° C.). Thereafter, the secondary battery was charged and discharged in the same environment to thereby measure the discharge capacity (a first cycle discharge capacity).

Thereafter, the secondary battery was repeatedly charged and discharged in the same environment until the total number of cycles reached 300 to thereby measure the discharge capacity (a 300th-cycle discharge capacity).

Lastly, a capacity retention rate that was an index for evaluating the cyclability characteristic was calculated based on the following calculation expression: capacity retention rate (%)=(300th-cycle discharge capacity/first-cycle discharge capacity)×100.

Upon charging, the secondary battery was charged with a constant current at a current density of 3 mA/cm² until a voltage reached 4.2 V, and was thereafter charged with a constant voltage of that value, 4.2 V, until the current density reached 0.7 mA/cm². Upon discharging, the secondary battery was discharged with a constant current at a current density of 3 mA/cm² until the voltage reached 3.0 V.

TABLE 1

| | Alkali metal | | | | |
|---|---|---|---|---|---|
| | carbonic acid | | Magnesium | | |
| | compound | | compound | | Capacity |
| | | Content | | Content | retention |
| | Kind | (wt %) | Kind | (wt %) | rate (%) |
| Example 1 | Li₂CO₃ | 0.6 | MgO | 1 | 69 |
| Example 2 | LMC | 0.6 | MgO | 1 | 72 |
| Example 3 | LEC | 0.6 | MgO | 1 | 70 |
| Example 4 | LPC | 0.6 | MgO | 1 | 52 |
| Example 5 | LEDC | 0.2 | MgO | 1 | 68 |
| Example 6 | LEDC | 0.5 | MgO | 1 | 75 |
| Example 7 | LEDC | 0.6 | MgO | 1 | 81 |
| Example 8 | LEDC | 0.8 | MgO | 1 | 61 |
| Example 9 | LPDC | 0.6 | MgO | 1 | 45 |
| Example 10 | LEDC | 0.6 | MgO | 0.01 | 41 |
| Example 11 | LEDC | 0.6 | MgO | 0.05 | 54 |
| Example 12 | LEDC | 0.6 | MgO | 0.5 | 73 |
| Example 13 | LEDC | 0.6 | MgO | 2 | 79 |
| Example 14 | LEDC | 0.6 | MgO | 5 | 71 |
| Example 15 | LEDC | 0.6 | MgF₂ | 1 | 77 |
| Example 16 | LEDC | 0.6 | Mg₃N₂ | 1 | 74 |
| Example 17 | LEDC | 0.6 | MgCO₃ | 1 | 73 |
| Comparative | — | — | — | — | 19 |
| example 1 | | | | | |
| Comparative | LEDC | 0.6 | — | — | 25 |
| example 2 | | | | | |
| Comparative | — | — | MgO | 1 | 37 |
| example 3 | | | | | |

As indicated in Table 1, the capacity retention rate varied greatly depending on the configuration of the negative electrode 22.

In the following, the capacity retention rate of the case where the negative electrode active material layer 22B included neither the alkali metal carbonic acid compound nor the magnesium compound (Comparative example 1) was used as a comparison reference.

Specifically, when the negative electrode active material layer 22B included only the alkali metal carbonic acid compound (Comparative example 2), the capacity retention rate slightly increased. Likewise, also when the negative electrode active material layer 22B included only the magnesium compound (Comparative example 3), the capacity retention rate slightly increased. Accordingly, it was expected that even if the negative electrode active material layer 22B included both the alkali metal carbonic acid compound and the magnesium compound, the capacity retention rate would increase only slightly.

However, when the negative electrode active material layer 22B included both the alkali metal carbonic acid compound and the magnesium compound (Examples 1 to 17), results against the expectation described above were obtained. That is, when the negative electrode active material layer 22B included both the alkali metal carbonic acid compound and the magnesium compound, the capacity retention rate increased markedly.

Here, the results against the expectation mentioned above will be described in detail.

First, when the negative electrode active material layer 22B included only the alkali metal carbonic acid compound (Comparative example 2), an increase rate of the capacity retention rate was about 31.6%. Further, when the negative electrode active material layer 22B included only the magnesium compound (Comparative example 3), the increase rate of the capacity retention rate was about 94.7%. Accordingly, it was expected that when the negative electrode active material layer 22B included both the alkali metal carbonic acid compound and the magnesium compound, the increase rate of the capacity retention rate would be about 126.3% (=31.6%+94.7%). This increase rate of about 126.3% was a value greater than 100%, and was thus apparently a sufficient value, but was still an insufficient value in view of improving the cyclability characteristic as much as possible.

In contrast, when actually checking the case where the negative electrode active material layer 22B included both the alkali metal carbonic acid compound and the magnesium compound (Example 7), the increase rate of the capacity retention rate was about 326.3%. This increase rate of about 326.3% was a value corresponding to about 2.5 times the above-described expected increase rate of about 126.3%, and was a markedly high value against the expectation. The increase rate of about 326.3% was therefore a sufficient value in view of improving the cyclability characteristic as much as possible.

In particular, an advantageous tendency that the capacity retention rate became markedly high when the negative electrode active material layer 22B included both the alkali metal carbonic acid compound and the magnesium compound was a special tendency that could not be easily derived unless the checking was actually performed.

When the negative electrode active material layer 22B included both the alkali metal carbonic acid compound and the magnesium compound (Examples 1 to 17), the following tendencies were obtained in particular. First, a high capacity retention rate was obtained even if the kind of the alkali metal carbonic acid compound (lithium carbonate, the first alkali metal carbonic acid compound, and the second alkali metal carbonic acid compound) was changed. Second, a high capacity retention rate was obtained even if the kind of the magnesium compound was changed. Third, when the content of the alkali metal carbonic acid compound in the negative electrode active material layer 22B was within the range from 0.2 wt % to 0.8 wt % both inclusive, a high capacity retention rate was obtained. Fourth, when the content of the magnesium compound in the negative electrode active material layer 22B was within the range from 0.01 wt % to 5 wt % both inclusive, a high capacity retention rate was obtained.

Based upon the results presented in Table 1, when the negative electrode active material layer 22B of the negative electrode 22 included both the alkali metal carbonic acid compound and the magnesium compound, a high capacity retention rate was obtained. Accordingly, the cyclability characteristic improved. It was therefore possible for the secondary battery to achieve a superior battery characteristic.

Although the present technology has been described above with reference to some embodiments and Examples, the configuration of the present technology is not limited to those described with reference to the embodiments and Examples above, and is therefore modifiable in a variety of ways.

For example, the description has been given of the case where the secondary battery has a battery structure of the laminated-film type. However, the battery structure of the secondary battery is not particularly limited, and may be of any other type such as a cylindrical type, a prismatic type, a coin type, or a button type.

Further, the description has been given of the case where the battery device has a device structure of a stacked type, and the case where the battery device has a device structure of a wound type. However, the device structure of the battery device is not particularly limited, and may be of any other type such as a zigzag folded type. In the zigzag folded type, the positive electrode and the negative electrode are opposed to each other with the separator interposed therebetween, and are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

Note that the present technology may have the following configurations according to an embodiment.

<1>

A secondary battery including:
a positive electrode;
a negative electrode including a negative electrode active material layer; and
an electrolytic solution, in which
the negative electrode active material layer includes an alkali metal carbonic acid compound and a magnesium compound,
the alkali metal carbonic acid compound has a carbonate bond (—OC(═O)O—), and includes an alkali metal element as a constituent element, and
the magnesium compound includes magnesium as a constituent element.
   <2>

The secondary battery according to <1>, in which the alkali metal carbonic acid compound includes at least one of lithium carbonate (Li₂CO₃), a compound represented by Formula (1), or a compound represented by Formula (2),

R1—OC(═O)o—M1 (1)
where
R1 is an alkyl group, and
M1 is an alkali metal element,

M2—OC(═O)O—R2—OC(═O)O—M3 (2)
where
R2 is an alkylene group, and
each of M2 and M3 is an alkali metal element.
   <3>

The secondary battery according to <2>, in which
in Formula (1) above, the alkali metal element includes lithium, and
in Formula (2) above, the alkali metal element includes lithium.
   <4>

The secondary battery according to any one of <1> to <3>, in which the magnesium compound includes at least one of magnesium fluoride, magnesium oxide, magnesium nitride, or magnesium carbonate.

<5>

The secondary battery according to any one of <1> to <4>, in which a content of the alkali metal carbonic acid compound in the negative electrode active material layer is greater than or equal to 0.2 weight percent and less than or equal to 0.8 weight percent.

<6>

The secondary battery according to any one of <1> to <5>, in which a content of the magnesium compound in the negative electrode active material layer is greater than or equal to 0.01 weight percent and less than or equal to 5 weight percent.

<7>

The secondary battery according to any one of <1> to <6>, in which
the negative electrode active material layer includes a negative electrode active material, and
the negative electrode active material includes a carbon material and a silicon-containing material.
   <8>

The secondary battery according to any one of <1> to <7>, in which the secondary battery includes a lithium-ion secondary battery.

<9>

A negative electrode for a secondary battery, the negative electrode including
a negative electrode active material layer, in which
the negative electrode active material layer includes an alkali metal carbonic acid compound and a magnesium compound,
the alkali metal carbonic acid compound has a carbonate bond (—OC(═O)O—), and includes an alkali metal element as a constituent element, and
the magnesium compound includes magnesium as a constituent element.

It should be understood that various changes and modifications to the embodiments described herein will be apparent to those skilled in the art. Such changes and modifications can be made in the spirit and scope of the present subject matter and without diminishing its intended advantages. It is therefore intended that such changes and modifications be covered by the appended claims.

1. A secondary battery comprising:
a positive electrode;
a negative electrode including a negative electrode active material layer; and
an electrolytic solution, wherein
the negative electrode active material layer includes an alkali metal carbonic acid compound and a magnesium compound,
the alkali metal carbonic acid compound has a carbonate bond (—OC(═O)O—), and includes an alkali metal element as a constituent element, and
the magnesium compound includes magnesium as a constituent element.

2. The secondary battery according to claim 1, wherein the alkali metal carbonic acid compound includes at least one of lithium carbonate (Li₂CO₃), a compound represented by Formula (1), or a compound represented by Formula (2),
R1—OC(═O)O—M1 (1)
where
R1 is an alkyl group, and
M1 is an alkali metal element,
M2—OC(═O)O—R2—OC(═O)O—M3 (2)
where
R2 is an alkylene group, and
each of M2 and M3 is an alkali metal element.

3. The secondary battery according to claim 2, wherein
in Formula (1) above, the alkali metal element comprises lithium, and
in Formula (2) above, the alkali metal element comprises lithium.

4. The secondary battery according to claim 1, wherein the magnesium compound includes at least one of magnesium fluoride, magnesium oxide, magnesium nitride, or magnesium carbonate.

5. The secondary battery according to claim 1, wherein a content of the alkali metal carbonic acid compound in the negative electrode active material layer is greater than or equal to 0.2 weight percent and less than or equal to 0.8 weight percent.

6. The secondary battery according to claim 1, wherein a content of the magnesium compound in the negative electrode active material layer is greater than or equal to 0.01 weight percent and less than or equal to 5 weight percent.

7. The secondary battery according to claim 1, wherein
the negative electrode active material layer includes a negative electrode active material, and
the negative electrode active material includes a carbon material and a silicon-containing material.

8. The secondary battery according to claim 1, wherein the secondary battery comprises a lithium-ion secondary battery.

9. A negative electrode for a secondary battery, the negative electrode comprising
a negative electrode active material layer, wherein
the negative electrode active material layer includes an alkali metal carbonic acid compound and a magnesium compound,
the alkali metal carbonic acid compound has a carbonate bond (—OC(═O)O—), and includes an alkali metal element as a constituent element, and
the magnesium compound includes magnesium as a constituent element.
